(19) United States
(12) Patent Application Publication
(10) Pub. No.: US 2001/0052935 A1
(43) Pub. Date: Dec. 20, 2001

(54) Image processing apparatus

(76) Inventor: Kotaro Yano, Tokyo (JP)

Correspondence Address: FITZPATRICK CELLA HARPER & SCINTO, 30 ROCKEFELLER PLAZA, NEW YORK, NY, 10112, US

(21) Appl. No.: 09/866,667

(22) Filed: May 30, 2001

(30) Foreign Application Priority Data
Jun. 2, 2000 (JP) 166793/2000

(51) Int. Cl. H04N 5/225; H04N 9/04

(52) U.S. Cl. 348/207

(57) ABSTRACT

In an image processing apparatus, a stereo image is photographed by fitting a stereophotographic adapter to a camera for photographing an object image. A depth map representing a depthwise distribution of an object is extracted from the stereo image. A multi-viewpoint image sequence of the object looking from multiple viewpoints is generated based on the stereo image and the depth map. A three-dimensional image is synthesized based on the multi-viewpoint image sequence. Further, a printer prints the three-dimensional image for enabling a stereoscopic image of the object to be observed with an optical member such as a lenticular sheet.

### BACKGROUND OF THE INVENTION

1. Field of the Invention

The present invention relates to an image processing apparatus for forming a stereoscopic (three-dimensional) image, a stereophotographic printing system including the image processing apparatus, and so on.

2. Description of the Related Art

Hitherto, integral photography and a lenticular sheet three-dimensional image system are known as methods for forming a stereoscopic image (see T. Okoshi, “Three-Dimensional Imaging Techniques”, Academic Press, New York, 1976).

Such a stereoscopic image forming method (first conventional method) is a photographic one. For example, a lenticular plate three-dimensional image is formed by shooting an object from multiple viewpoints to acquire respective images and printing these images on one photographic film through a lenticular sheet. The first conventional method therefore has the following problems (1) to (3).

(1) An elaborate, large-scale shooting apparatus, e.g., a multi-lens camera, is required for acquiring images of an object shot from multiple viewpoints. (2) Similarly, an elaborate, large-scale printing apparatus is required for forming a stereoscopic image. (3) Specific adjustment and skill are required in shooting and printing even with the use of those elaborate, large-scale shooting and printing apparatuses.

To overcome the above problems, Japanese Patent Laid-Open No. 5-210181 discloses a method (second conventional method) of producing images looking from an increased number of viewpoints based on images shot from multiple viewpoints by interpolation, and electronically processing the produced images to form a stereoscopic image. In other words, this related art is intended to simplify the stereoscopic image formation process by utilizing not only electronic interpolation of images to reduce the number of viewpoints necessary for obtaining the images by shooting, but also recent digital photography. Because of requiring a plurality of images, however, the second conventional method still has problems that a difficulty occurs in shooting and a moving object cannot be photographed.

To overcome those problems in shooting, a system for forming a stereophotographic image, shown in FIG. 10, has been proposed in which an adapter is mounted to a camera so that a stereo image consisted of two image from left and right viewpoints may be photographed at a time.

In FIG. 10, numeral 1 denotes an object, 2 denotes a camera, and 3 denotes an adapter. Also, numeral 21 denotes a shooting lens of the camera, 22 denotes a photographed image plane, 31 denotes a prism, and 32, 33 denote mirrors. Further, O denotes the lens center (specifically the viewpoint or the center of an entrance pupil) of the shooting lens 21. Also, l denotes an optical axis of the shooting lens 21, and m, n denote principal light rays of luminous fluxes passing the centers of a left-eye image area and a right-eye image area in the photographed image plane 22. As shown, the adapter 3 is bilaterally symmetrical with respect to the optical axis l of the shooting lens 21.

A left-eye object image is reflected by the mirror 32 and the prism 31, passes the shooting lens 21, and then reaches a right-half area of the photographed image plane 22. Likewise, a right-eye object image is reflected by the mirror 33 and the prism 31, passes the shooting lens 21, and then reaches a left-half area of the photographed image plane 22. With such an arrangement, the left-eye and right-eye images can be formed in the photographed image plane 22. It is conceivable that, from the left and right stereo images thus acquired, multi-viewpoint images are obtained by electronic interpolation to form a stereoscopic image (third conventional method).

Of the above-described conventional methods for forming a stereoscopic image, the second conventional method is able to overcome the problems with the first conventional one that the elaborate, large-scale shooting and printing apparatuses are required and specific adjustment and skill are also required in shooting and printing. The third conventional method is able to overcome the problem with the second conventional one, i.e., difficulties in shooting. However, there has not yet been realized a system capable of simply forming a high-quality stereoscopic image independently of the object and shooting conditions, etc., taking into account various elements of the problems with the conventional methods from the overall point of view.

### SUMMARY OF THE INVENTION

In view of the above problems with the conventional methods, it is an object of the present invention to provide a stereophotographic printing system and so on, which can easily shoot an object, can easily obtain a high-quality stereoscopic image, and enables a stereoscopic image of the object to be more satisfactorily observed by placing an optical member, such as a lenticular sheet, on the stereoscopic image.

Another object of the present invention is to provide a more convenient stereophotographic printing system and so on, in which a photographed image is once recorded as digital image data and then can be printed through a network.

To achieve the above objects, according to one aspect, the present invention discloses an image processing apparatus comprising a depth map extracting unit for extracting a depth map, which represents a depthwise distribution of an object, from a stereo image containing object images looking from multiple viewpoints and formed in the same image plane; a multi-viewpoint image sequence generating unit for generating a multi-viewpoint image sequence of the object looking from the multiple viewpoints based on the stereo image and the depth map; and a three-dimensional image synthesizing unit for synthesizing a three-dimensional image based on the multi-viewpoint image sequence.

Also, according to another aspect, the present invention discloses a stereophotographic printing system comprising a camera for photographing an object image; a stereophotographic adapter mounted to the camera for photographing object images looking from multiple viewpoints, as a stereo image, in the same photographed image plane of the camera; an image processing apparatus for extracting a depth map, which represents a depthwise distribution of an object, from the stereo image, generating a multi-viewpoint image sequence of the object looking from the multiple viewpoints based on the stereo image and the depth map, and synthesizing a three-dimensional image based on the multi-viewpoint image sequence; and a printer for printing the three-dimensional image for enabling a stereoscopic image of the object to be observed with an optical member.

Further objects, features and advantages of the present invention will become apparent from the following description of the preferred embodiments with reference to the attached drawings.

### BRIEF DESCRIPTION OF THE DRAWINGS

FIG. 1 is a block diagram showing a configuration of a stereophotographic printing system according to an embodiment of the present invention;

FIG. 2 shows one example of a photographed image;

FIG. 3 is a flowchart diagram showing an algorithm of a processing program used in the stereophotographic printing system of the present invention;

FIG. 4 shows left and right images resulting after compensating for trapezoidal distortions of the image shown in FIG. 2;

FIG. 5 shows a pair of stereo images acquired from the images shown in FIG. 4;

FIG. 6 shows a depth map determined from the pair of stereo images shown in FIG. 5;

FIG. 7 shows part of an image sequence generated from the image of FIG. 2;

FIG. 8 shows a multiplexed striped image corresponding to the image of FIG. 2;

FIG. 9 shows an enlarged image of part of the multiplexed striped image corresponding to the image of FIG. 2; and

FIG. 10 is a block diagram showing a conventional stereophotographic image forming system.

### DESCRIPTION OF THE PREFERRED EMBODIMENTS

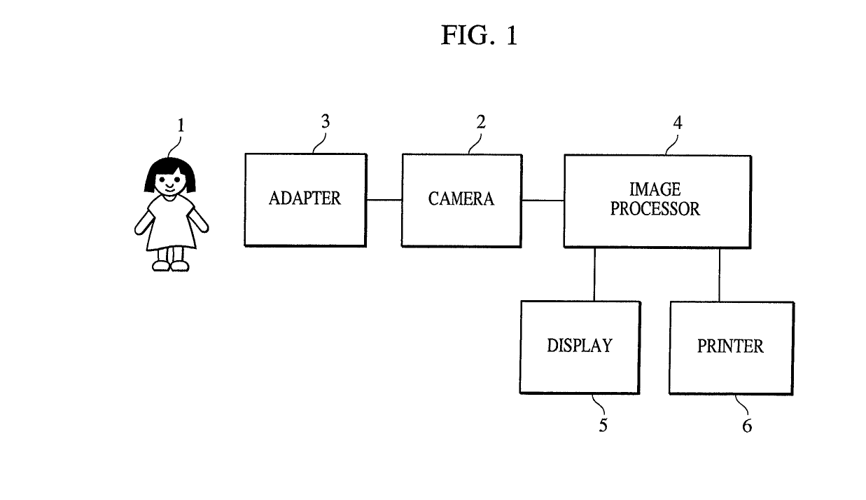

An embodiment of the present invention will now be described with reference to the drawings. FIG. 1 is a block diagram showing a configuration of a stereophotographic printing system according to the embodiment of the present invention.

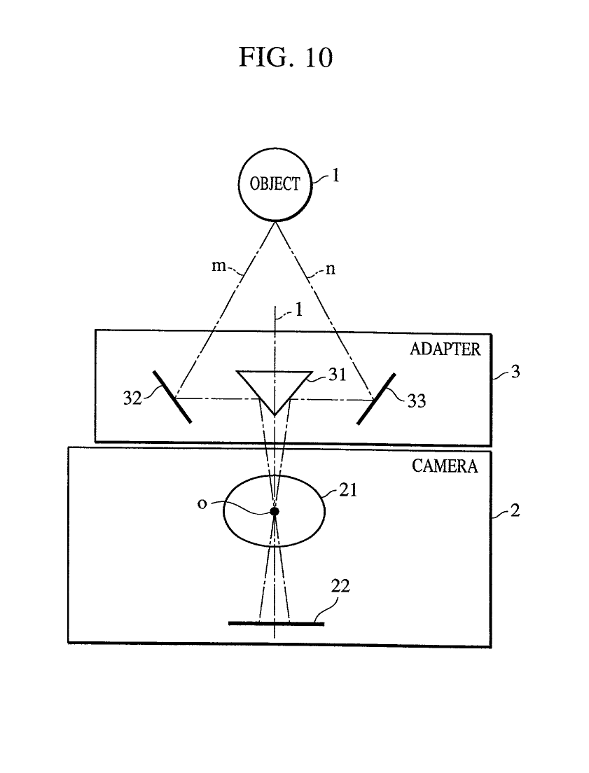

Referring to FIG. 1, numerals 1, 2 and 3 denote the same components as those shown in FIG. 10, i.e., an object, a camera, and an adapter, respectively.

The camera 2 is, e.g., a digital camera capable of storing or outputting a photographed image after conversion into an electrical signal. Numeral 4 denotes an image processor constituted by, e.g., a personal computer (PC). Numeral 5 denotes a display unit connected to the image processor 4 and constituted by, e.g., a CRT display, for displaying an image and information processed by the image processor 4. Numeral 6 denotes a printer connected to the image processor 4 and constituted so as to print image data, etc. produced by the image processor 4. The camera 2 and the printer 6 are connected to the image processor 4 using an interface such as a USB (universal Serial Bus).

As with the above-described third conventional method, an object is photographed by the camera 2 including the adapter 3 mounted to it. For example, when shooting an object by the camera 2 in a high-resolution mode selected as one of shooting modes, an image of 2048×1536 pixels is taken in and then recorded in a CF (Compact Flash) card after being subjected to JPEG compression. Accordingly, a stereo image of the object 1 looking from two left and right viewpoints is recorded as one image file of 2048×1536 pixels.

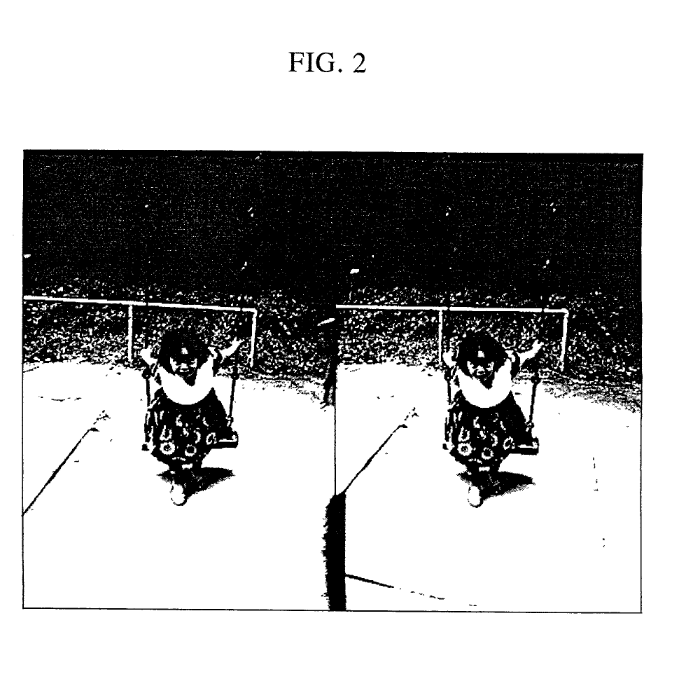

FIG. 2 shows one example of a thus-photographed image. In this connection, when the shooting lens comprises a zoom lens, it is preferable to take a photograph at the wide-angle end. Because images from two viewpoints are photographed in one image, the visual field is narrower than that in ordinary shooting, and when shooting a stereophotographic image, a three-dimensional appearance can be relatively easily obtained by taking a photograph as close as possible to the object with wide-angle shooting. Another reason is that a wider visual field makes it possible to shoot an object distributing over a wider range from a near distance to a far distance, and to more easily provide a composition with a three-dimensional appearance.

Further, a strobe flash is preferably inhibited when shooting an object. The reason is that, particularly for an object having a surface whose reflectance provides a high direct reflection component, a strobe light reflected by the object may enter an image photographed by the camera 2 and image information of the object surface may be impaired.

Subsequently, the stereo image thus photographed is taken into the image processor 4. The image data recorded in the camera 2 is once recorded in a hard disk of the PC through the USB interface by, for example, booting up driver software of the camera 2 within the PC which constitutes the image processor 4, and then performing a predetermined operation.

When the image processor 4 has a PC card slot, the image data recorded in the CF card can be handled in the same manner as the image data recorded in the hard disk of the PC by disconnecting the CF card from the camera 2, mounting the CF card to a CF card adapter which can be inserted to the PC card slot, and inserting the CF card adapter to the PC card slot with no need of connecting the camera 2 and the image processor 4 to each other.

The image processor 4 processes the stereo image thus taken in to automatically generate multi-viewpoint images of the object, synthesize a three-dimensional image, and outputs the three-dimensional image to the printer 6. A sequence of these processing steps are executed, for example, by application software installed in the PC. Details of a processing program executed by the image processor 4 will be described below.

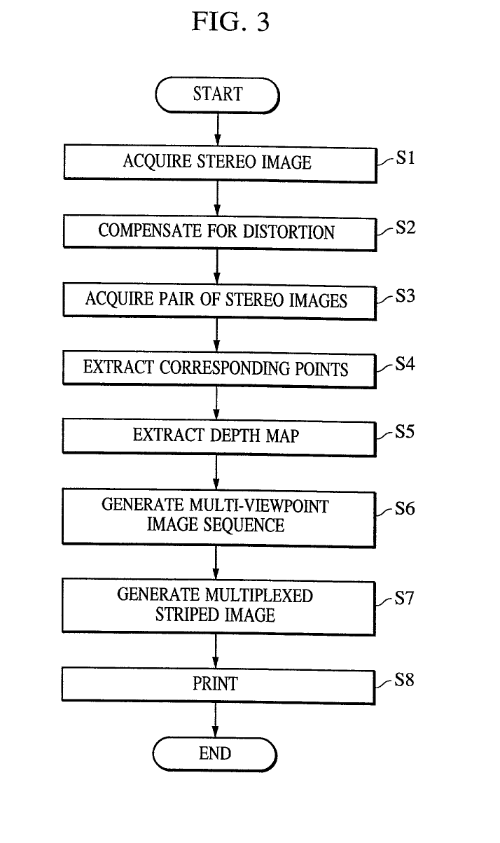

FIG. 3 is a flowchart diagram showing an algorithm of a processing program used in the stereophotographic printing system of this embodiment. The following control method can be realized by storing and executing the program in accordance with the flowchart in a built-in memory of the image processor 4.

<Process of Acquiring Stereo Image: Step S1>

First, in step S1, the memory of the PC constituting the image processor 4 takes in a stereo image for conversion into data capable of being handled by the processing program. At this time, a file of the stereo image is designated through an input device (not shown), e.g., a keyboard, and the designated file is read into the program. On this occasion, the image data is converted into two-dimensional array data or bit map of three RGB channels. Particularly, if the inputted stereo image data is in JPEG image format, conversion of the image data, such as decompression of a JPEG image, is required because it is difficult to process the image data directly.

<Process of Compensating for Distortion: Step S2>

Step S2 compensates for trapezoidal distortions of the stereo image occurred upon the shooting. In this step S2, the stereo image is first divided into left and right image data. More specifically, when an image of RGB channels is given by the stereo image data in a two-dimensional array of M (horizontal)×N (vertical), the stereo image is divided into two sets of image data of M/2 (horizontal)×N (vertical) with respect to a boundary defined by a vertical line passing the image center. Assuming, for example, that the stereo image data comprises 2048×1536 pixels, each set of divided image data comprises 1024×1536 pixels.

Then, in accordance with shooting parameters of the camera 2 and the adapter 3, the compensation of trapezoidal distortions is performed through the same angle in opposite directions on the left and right sides about the centers of image areas of the left and right image data so that imaginary photographed image planes after the compensation of trapezoidal distortions are parallel to each other. This compensation is indispensable because left and right optical paths are each given with a predetermined vergence angle and each of the left and right images necessarily includes a trapezoidal distortion. The process of compensating for the trapezoidal distortion is carried out through the so-called geometrical transform using a three-dimensional rotating matrix of an image.

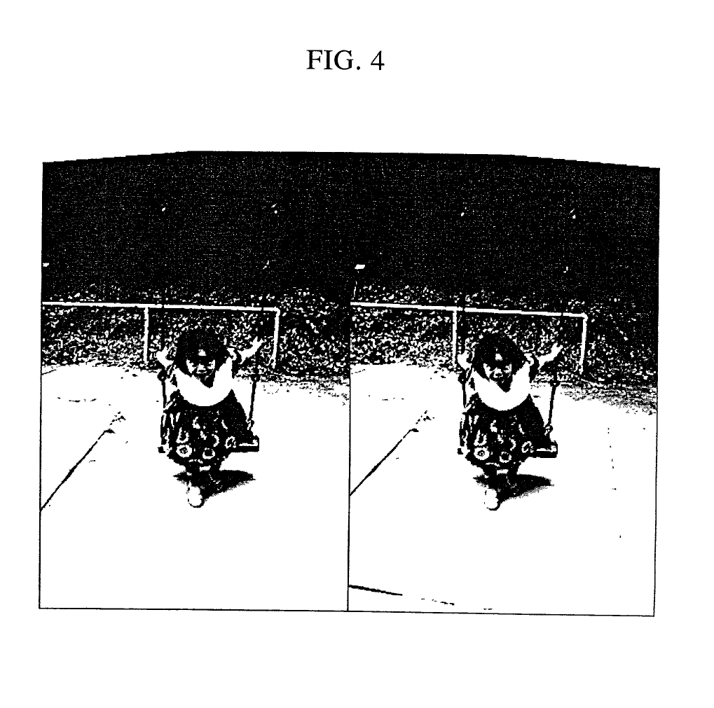

FIG. 4 shows left and right images resulting after compensating for the trapezoidal distortions of the image shown in FIG. 2.

Depending on the object position, the focal length of the shooting lens of the camera 2, and the construction of the adapter 3, the amount of trapezoidal distortion occurred in the photographed stereo image may be so small as negligible. In such a case, the processing of step S2 is not required.

<Process of Acquiring Pair of Stereo Images: Step S3>

In step S3, a pair of left and right stereo images each having a predetermined size are acquired from the compensated left and right image data, respectively. First, in this step S3, a position shift amount between the left and right image data is determined. The reason is as follows. Although the same portion of the object 1 is preferably photographed as the left and right image data, the horizontal shift amounts of the image data differ from each other depending on the distance from the camera 2 to the object 1 at the time of shooting and a distribution of the object 1 in the depthwise direction away from the camera. Therefore, image positions of the respective image data having been subjected to the compensation of trapezoidal distortions must be adjusted.

Another reason is that an adjustment in the vertical direction is also required, because the process of compensating for trapezoidal distortions in step S2 is carried out in accordance with certain shooting conditions of the camera 2 and the adapter 3 and the left and right images are sometimes not obtained in a perfectly parallel viewing state due to effects such as caused by a mounted condition of the adapter 3 to the camera 2 and shifts of the components 31, 32, 33.

For those reasons, the position shift amount between the left and right image data is determined by template matching so that the left and right image data may contain the same portion of the object in most areas. The contents of this processing will be briefly described below.

Scaled-down images of the left and right image data after being subjected to the compensation of trapezoidal distortions are first prepared for determining the position shift amount between the left and right image data in a shorter time. Although depending on the size of the photographed stereo image, a scale-down factor is preferably about ¼ when the original size is on the order of 2048×1536 pixels. If the image is excessively scaled down, the accuracy of the position shift amount to be determined is deteriorated.

Subsequently, a template image is prepared by cutting image data of a predetermined rectangular area out of the scaled-down left image. Then, the sum of differences in pixel value between the image data of the predetermined rectangular area cut out of the left image and the image data of an equal rectangular area in the right image is calculated over a predetermined amount of movement in each of the horizontal and vertical directions. As a result, the amount of movement, at which the sum of differences in pixel value is minimum, is determined as the position shift amount. This process of determining the position shift amount may be executed for the image data of, e.g., the G channel among the three RGB channels.

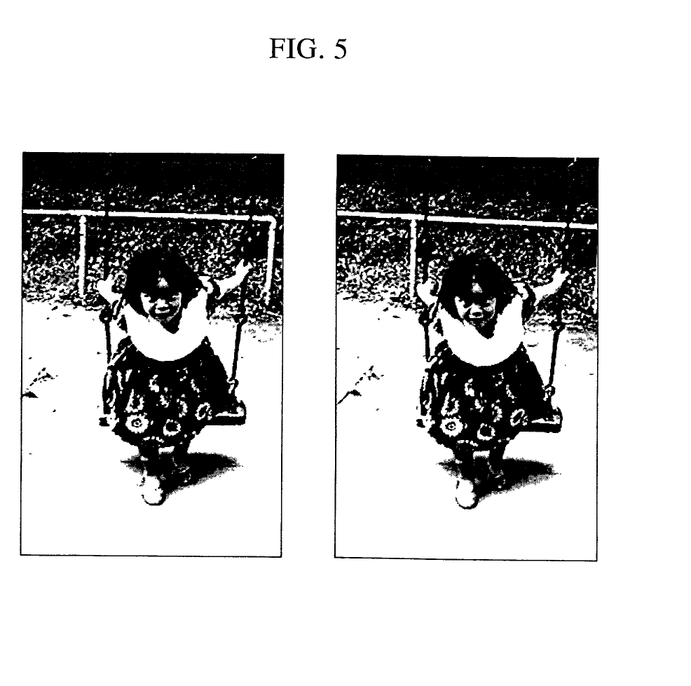

After the above processing, from the left and right image data after being subjected to the compensation of trapezoidal distortions, partial areas of the same size are acquired as a pair of stereo images while displacing the image data through the determined position shift amount. When the size of the original stereo image is on the order of 2048×1536 pixels, it is appropriate that images each containing about 600×800 pixels be acquired. Also, when landscape images are desired as the pair of stereo images, it is appropriate that images each containing about 640×480 pixels be acquired. FIG. 5 shows a pair of stereo images acquired from the images shown in FIG. 4.

<Process of Extracting Corresponding Points: Step S4>

Returning to FIG. 3, in step S4, corresponding points representing the same portion of the object in point-to-point correspondence between the pair of acquired stereo images are extracted from the images. The corresponding points are extracted by applying template matching to each point.

First, from the left image of the pair of stereo images, a partial area of a predetermined size about a predetermined point is cut out as a template. Then, corresponding points in the right image are determined. The position, from which each template is cut out at this time, is set such that the center of the templates is located in the left image at predetermined intervals in each of the vertical and horizontal directions. By determining the corresponding points over the entire image area without polarization, a stable three-dimensional appearance is obtained over the entire image area through subsequent processing. The corresponding points may be determined for all points in the image, but a processing time would be too long if the image size is large.

Also, among the three RGB channels of the image data, the channel that provides the greatest variance of pixel values in the template is selected as one, for which the extraction of the corresponding points is to be made on selected points. In the extraction of the corresponding points, a degree of correlation between the template and an image area having the same size in the right image is calculated by determining the sum of differences in pixel value therebetween about a point in a predetermined area selected for search of the corresponding point in the right image.

The search area for the corresponding point is set as a predetermined horizontal range with respect to a point in the left image because the pair of stereo images in a nearly parallel viewing state are obtained through the processing in step S3. Also, it is desired for preventing erroneous determination in the search of the corresponding point that when information regarding the depthwise direction away from the camera, e.g., the distance range of the object, is given beforehand, the horizontal search range is limited to the least necessary one in accordance with such information.

The result of calculating the correlation is obtained in the form of a one-dimensional distribution, and the position of the corresponding point is determined by analyzing the obtained distribution. The position at which the sum of differences is minimum is determined as the position of the corresponding point. However, if the sum of differences at the position of the corresponding point (i.e., the minimum sum of differences) is greater than a predetermined value, or if the difference between the sum of differences at the position of the corresponding point and the second minimum sum of differences is smaller than a predetermined value, or if change in the sum of differences near the position of the corresponding point is smaller than a predetermined value, information indicating “not corresponding” is given to such a point because reliability in the process of extracting the corresponding point is thought to be low.

Further, for the corresponding point thus determined, a template is conversely cut out about the corresponding point in the right image, and the search of the corresponding point in the left image is carried out in the horizontal direction. It is then determined whether the resulted corresponding point is in the vicinity of the position of the corresponding point in the left image. If the resulted corresponding point is away a predetermined distance or more from the position of the corresponding point, information indicating “not corresponding” is given to such a point because of a high possibility that the corresponding point is based on erroneous determination. A plurality of corresponding points between the pair of left and right stereo images are determined over the entire image area by repeating the above-described processing.

<Process of Extracting Depth Map: Step S5>

In step S5, a depth map is extracted from the corresponding points. Herein, the depth map represents a horizontal position shift of the position of the corresponding point in the right image with respect to each pixel in the left image of the pair of stereo images. The depth can be directly determined from the difference in horizontal positions of the corresponding points extracted. In addition, the depth is also determined by interpolation for the not corresponding points and the other points for which the search of the corresponding point has not been made at all.

More specifically, the depth of each point, which has been determined to be “not corresponding” in the process of extracting the corresponding points, is first estimated from the position of the other corresponding point which has been determined to be “corresponding”. The depth d of the not corresponding point is determined from the following formula (1) by calculating a weighted average of the depths of the corresponding points determined in the process of extracting the corresponding points while using, as a weight, a parameter of the distance between the not corresponding point and each corresponding point at the position of the corresponding point in the left image:

d=Σᵢwᵢ×dᵢ/Σᵢwᵢ (1)

where wᵢ={(x−xᵢ)²+(y−yᵢ)²}⁻ⁿ

dᵢ=xᵢ′−xᵢ: depth determined from extraction of the corresponding point

(x, y): position in the left image of the not corresponding point for which depth is to be determined

(xᵢ, yᵢ): position in the left image of the corresponding point determined from extraction of the corresponding point

(xᵢ′, yⁱ′): position in the right image of the corresponding point determined from extraction of the corresponding point

i: index of the corresponding point determined from extraction of the corresponding point

In the above formula (1), n represents a predetermined parameter. If a value of n is too small, the determined depth would be close to an average obtained from the overall image area and a depth distribution would be even. If a value of n is too large, the determined depth would be greatly affected by the near corresponding point. A value of n=1 or thereabout is preferable in consideration of a computing time as well. Through the above-described processing, the depth is determined at the predetermined equal intervals in each of the vertical and horizontal directions.

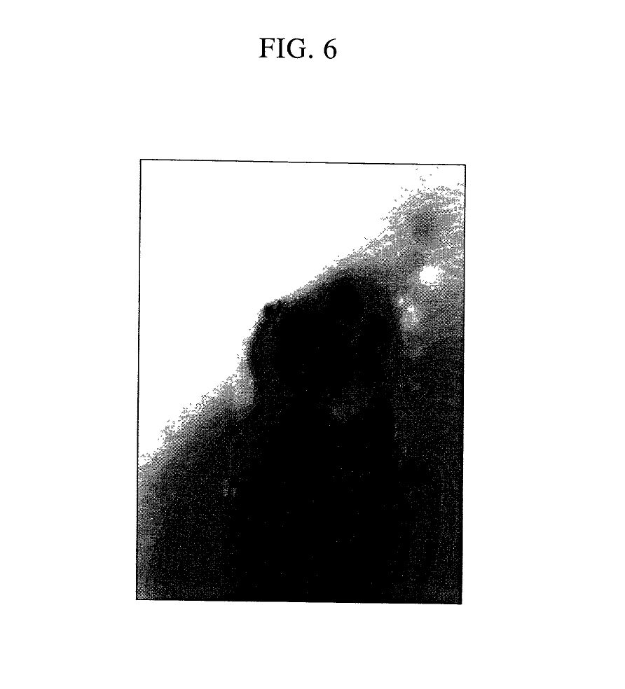

Subsequently, based on the depths thus determined, depths are further determined for those points for which the search of the corresponding point has not been made at all. Stated otherwise, since the depths are determined at predetermined intervals, the depth for each of those points is determined by interpolation from the four depths in the vicinity of the point for which the depth is to be determined. An interpolating method for determining the depth at this time follows the above-mentioned formula (1) except that only four depths in the vicinity of the target point are employed instead of those at all the corresponding points. In this case, dᵢ is the depth in the vicinity of the target point, and (xᵢ, yᵢ) is the position in the left image corresponding to the depth in the vicinity of the target point. Through the above processing, depths are determined for all pixels of the left image. The thus-determined depths are provided as a depth map. FIG. 6 shows a depth map determined from the pair of stereo images shown in FIG. 5.

A dark area in FIG. 6 represents a region at a shorter distance from the camera 2, and as the map becomes lighter, the distance from the camera 2 increases. A light area represents a background. The reason why the depth is interpolated in two stages in the above processing is that, when the number of corresponding points determined in step S4 is large, a great deal of calculations is required for interpolating the depths for all of the pixels based on all the corresponding points. Accordingly, when the number of corresponding points is relatively small, the depths may be determined for all of the pixels based on all the corresponding points. However, if the number of corresponding points is too small, a depth distribution would be nearly even and a three-dimensional appearance reflecting the object would not be obtained sometimes.

While the depth is interpolated by calculating a weighted average using a distance parameter as a weight in the above description, it may be interpolated by employing a parameter that represents a pixel value for each of the RGB channels in addition to the distance, and increasing a weight applied to the pixel that is located at a nearer spatial position and has a closer pixel value. Further, bilinear interpolation or spline interpolation, for example, may also be used instead.

<Process of Generating Multi-Viewpoint Image Sequence: Step S6>

In step S6, a multi-viewpoint image sequence is generated using the depth map obtained as described above. Images generated in this step are multi-viewpoint images constituting a multiplexed striped image, and the size of each image depends on the number of images and the resolution and the size of a print. Assuming that the resolution of the printer 6 is RP dpi (dot per inch) and the print size is XP×YP inch, the size of the printed image is given by X(=RP×XP)×Y(=RP×YP) pixels.

The number N of images is determined to be N=RP×RL in match with the pitch RL inch of a lenticular sheet. Since N is an integer, the number of images is set to an integer closest to RP×RL in practice. Assuming, for example, that the printer resolution is 600 dpi and the pitch of the lenticular sheet is 1/50.8 inch, N=12 is desired. In this case, the size of the image corresponding to each viewpoint is H(=X/N)×V(=Y). Practically, the print size is determined so that H and V each become an integer. Given H=200 and V=1800 pixels, for example, the print size is 4×3 inch because of X=2400 and Y=1800 pixels (in practice the print size varies somewhat due to the necessity of matching the pitch of the lenticular sheet and the image cycle (resolution of the printer) with each other; this processing is executed in step S7 described later).

Generated images are obtained by modifying the left image using the depth map. Assuming, for example, that the size of the left image is h(=800)×v(=600) pixels, an image of 200×600 pixels is generated by setting the number of horizontal pixels equal to H and the number of vertical pixels equal to v. This is because the number of vertical pixels of each image required for printing is much greater than the number of horizontal pixels and a long processing time is taken in trying to generate a large-size image using the depth at a time.

The viewpoint position of each generated image is determined so as to provide a predetermined parallax amount. If the depth is too small, a three-dimensional appearance would be deteriorated when observing a three-dimensional image. Conversely, if the parallax amount is too large, a three-dimensional image would lose sharpness due to crosstalks with adjacent images when observed. Also, the viewpoint positions are determined such that the viewpoints are arranged at equal intervals and in symmetrical relation about the viewpoint position of the left image. The reasons are as follows. By arranging the viewpoint positions of the image sequence at equal intervals, a stable three-dimensional image can be observed. Further, by arranging the viewpoint positions in symmetrical relation about the viewpoint position of the left image, a deformation of the image can be minimized and a high-quality three-dimensional image can be stably obtained even if an error occurs in the depth map depending on the object and shooting conditions.

From the depth map prepared in step S5, the depth corresponding to the object position closest to the camera 2 and the depth corresponding to the farthest object position are determined. Then, the viewpoint position is determined so that, when observing the image from a predetermined position, the nearest object is observed at a position closer to the observer from the print surface by a predetermined distance and the farthest object is observed at a position farther away from the observer from the print surface by a predetermined distance.

On that occasion, a parameter practically used for generating the image depends on the depths of the pair of left and right stereo images. For example, a ratio r=0 represents the left image itself, and a ratio r=1 represents the image viewing at the viewpoint position of the right image. If the depth map contains an error, there may also occur an error in the depth of the nearest object and the farthest object. Therefore, the parameter for use in the image generation may be determined based on a statistical distribution over the entire depth map by a method not affected by an error.

The method of generating each viewpoint image will now be described. First, a new viewpoint image is generated by forward mapping using the pixels of the left image. More specifically, a position (xN, yN) in the new viewpoint image used for mapping the pixels of the left image is determined from the following formula (2) based on the depth d at the pixel position (x, y) in the left image, the ratio r representing the viewpoint position, the size of the left image, and the size of the new viewpoint image:

xN=H/h×(x+r×(d−sh)), yN=y (2)

Then, the pixel at the pixel position (x, y) in the left image is copied to the position (xN, yN) in the new viewpoint image. This processing is repeated for all pixels of the left image. Subsequently, a process of filling those of the pixels of the new viewpoint image, which are not assigned from the left image, is executed. This filling process is performed by searching for an effective pixel positioned a predetermined distance away from the target pixel, and assigning a weighted average value using the distance to the effective pixel. If no effective pixel is found, the search is repeated after enlarging a search area.

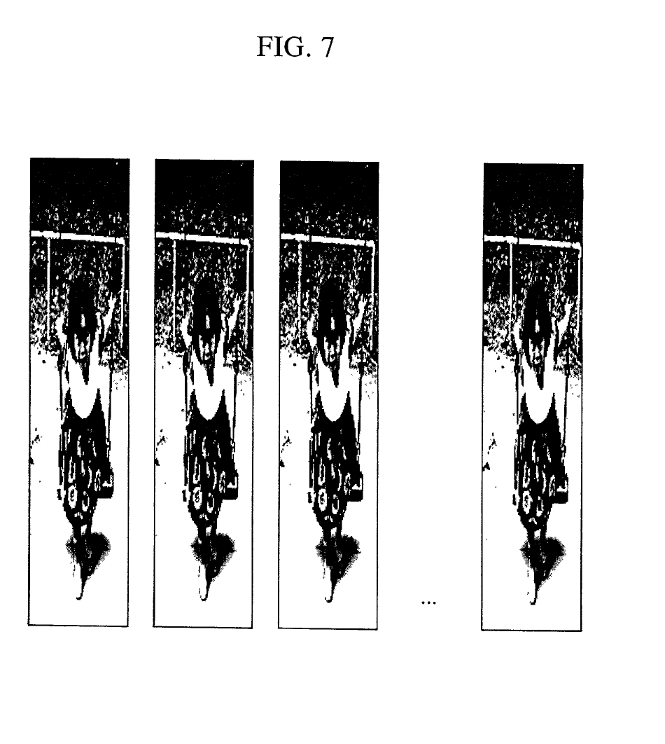

The new viewpoint image in which all the pixels are effective is generated through the above processing. By repeating that processing a number of times corresponding to the number of viewpoints, a multi-viewpoint image sequence is obtained. FIG. 7 shows part of the image sequence generated from the image of FIG. 2.

While the image sequence is generated by modifying the left image in the above description, it may be generated by modifying the right image. Alternatively, images generated by modifying the left and right images may be synthesized to generate the image sequence. However, since an error may occur in the depth map depending on the object and shooting conditions and different object images may be synthesized double as a result of synthesizing multiple images, it is preferable to generate the image sequence based on the image from one viewpoint for obtaining a high-quality image with stability.

<Process of Synthesizing Multiplexed Striped Image: Step S7>

In step S7, a multiplexed striped image is synthesized from the multiplexed striped image sequence. At this time, the multiplexed striped image is synthesized such that pixels of respective images of the multi-viewpoint image sequence, which have the same coordinates, are arranged as adjacent pixels in accordance with the viewpoint array of the images. Assuming that a pixel value at the j-th viewpoint is Pjmn (where m and n are indices of a pixel array in the horizontal and vertical directions, respectively), the j-th image data is represented as the following two-dimensional array:

Pj00 Pj10 Pj20 Pj30 . . .

Pj01 Pj11 Pj21 Pj31 . . .

Pj02 Pj12 Pj22 Pj32 . . .

. . .

The multiplexed striped image is generated by decomposing the image from each viewpoint position into striped images for each vertical line, and synthesizing the decomposed images in number of the viewpoints in order reversal to that of the viewpoint positions. Accordingly, the synthesized image is given as a stripe one represented as follows:

PN00 . . . P200P100PN10 . . . P210P110PN20 . . . P220P120 . . .

PN01 . . . P201P101PN11 . . . P211P111PN21 . . . P221P121 . . .

PN02 . . . P202P102PN12 . . . P212P112PN22 . . . P222P122 . . .

. . .

In the above stripe image, the viewpoint 1 represents a left end image and the viewpoint N represents a right end image. The reason why the array order of the viewpoint positions is reversed herein is that, when observing the synthesized image through a lenticular sheet, the image is observed reversely in the left and right direction within one pitch of the lenticular sheet. When the original multi-viewpoint image sequence comprises images of N viewpoints, each having a size of H×v, the synthesized three-dimensional stripe image has a size of X(=N×H)×v.

Then, the synthesized multiplexed striped image is enlarged (or reduced) so as to have a pitch in match with that of the lenticular sheet. In the image, one pitch contains N pixels at a rate of RP dpi (pixels per inch) and hence it is N/RP inch. On the other hand, the pitch of the lenticular sheet is RL inch. Therefore, the image is enlarged RL×RP/N times in the horizontal direction for matching in pitch with the lenticular sheet. Further, since the number of vertical pixels must be (RL×RP/N)×Y in this case, the image is also enlarged (RL×RP×Y)/(N×v) times in the vertical direction for scale matching.

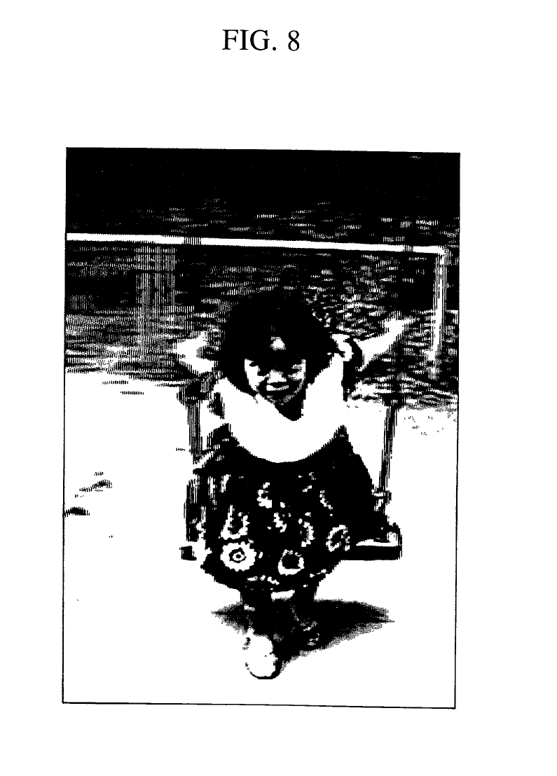

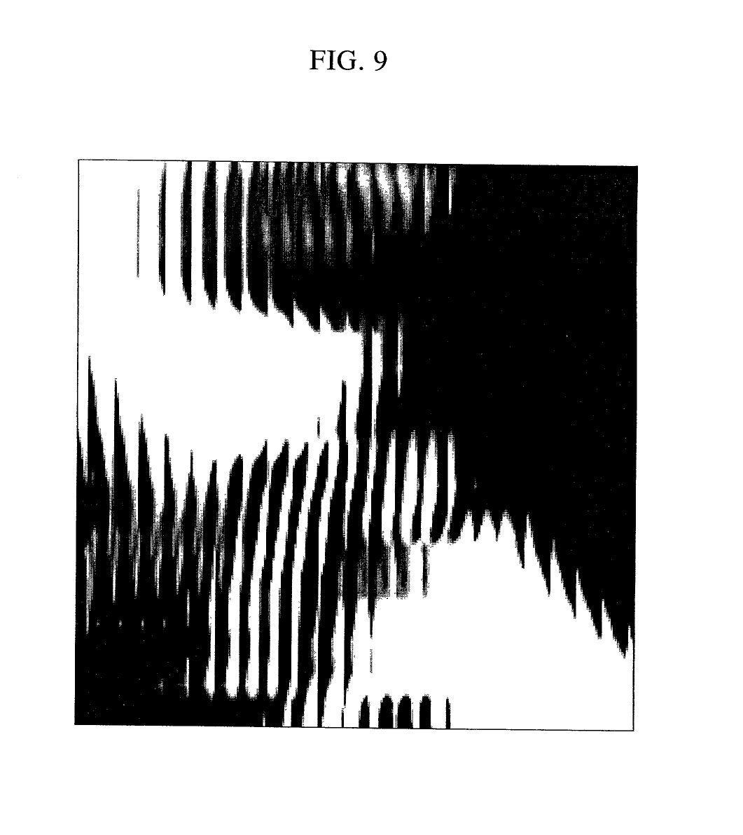

Thus, image data for printing is obtained by executing the above-described scaling process on the multiplexed striped image in the horizontal and vertical directions. The scaling process may be performed by bi-linear interpolation, for example. FIGS. 8 and 9 show respectively the three-dimensional stripe image and an enlarged image of part thereof corresponding to the image of FIG. 2.

<Printing Process: Step S8>

In step S8, an output image of step S7 is printed. In the printing process, printing is preferably controlled such that the vertical direction along stripes of multiplexed striped image is aligned with the direction of sub-scan in the printing in which the scan cycle is shorter. This contributes to reducing fringes occurred due to the cycle (pitch) of the lenticular sheet and the printing cycle when the image is observed through the lenticular sheet laid on the image. Prior to start of the printing, the results of the above-described steps, i.e., steps 1 to 7, may be displayed on the display unit 5 for confirmation.

A satisfactory stereoscopic image can be observed by placing the lenticular sheet on the image generated and printed through the processing of steps 1 to 8.

With this embodiment, in a system for observing a stereoscopic image by processing an image photographed by a camera to generate a three-dimensional image, printing the generated image, and placing a lenticular sheet or the like on the surface of the printed image, it is possible to realize simple shooting of an object and automation from processing of the photographed image to printing of the stereoscopic image.

In the above-described embodiment, the camera 2 is independently operated to record the photographed image in the CF card mounted to the camera, and the recorded image is then taken into a processing program. However, the camera 2 may be connected to the image processor 4, and the shooting mode and shooting control of the camera 2, including zoom and strobe operations, may be set and performed from the image processor 4 so that the photographed image is directly recorded in a built-in storage, e.g., a hard disk, of the image processor 4. As an alternative, the photographed image may be directly taken into a built-in memory of the image processor 4 so that image data is handled by the processing program at once.

Also, in the above-described embodiment, the image photographed by the camera 2 is once recorded in the hard disk of the image processor 4. Alternatively, for example, another PC is prepared as an image recording device and the image photographed by the camera 2 is once recorded in the image recording device so that the image processor 4 may read image data via a network. For example, one user A takes a photograph at a remote location, records an image photographed by the camera 2 in a portable PC, and connects the PC to the network. Another user B connects the PC, which constitutes the image processor 4 and is connected to the printer 6, to the network at another location so that the image data is directly taken into the processing program and a three-dimensional image is printed. As a result, the user B can observe the three-dimensional image. Further, the user A can remotely operate the image processor 4, whereupon the three-dimensional image is provided to the user A from a distant place at once.

While the embodiment uses a stereophotographic adapter capable of shooting images from two left and right viewpoints at the same time when fitted to the camera, the stereophotographic adapter may be one capable of shooting images from four upper, lower, left and right viewpoints at the same time. Further, while the embodiment has been described in connection with the stereophotographic printing system using the lenticular sheet three-dimensional image system, the present invention is also applicable to another stereophotographic printing system using the integral photography or a parallax barrier system.

Moreover, the present invention is not limited to the apparatus of the above-described embodiment, but may be applied to a system comprising plural pieces of equipment or to an apparatus comprising one piece of equipment. It is needless to say that the object of the present invention can also be achieved by supplying, to a system or apparatus, a storage medium which stores program codes of software for realizing the functions of the above-described embodiment, and causing a computer (or CPU and/or MPU) in the system or apparatus to read and execute the program codes stored in the storage medium.

In such a case, the program codes read out of the storage medium serve in themselves to realize the functions of the above-described embodiment, and hence the storage medium storing the program codes constitutes the present invention. Storage mediums for use in supplying the program codes may be, e.g., floppy disks, hard disks, optical disks, magneto-optical disks, CD-ROMS, CD-Rs, magnetic tapes, nonvolatile memory cards, and ROMS. Also, it is a matter of course that the functions of the above-described embodiment are realized by not only a computer reading and executing the program codes, but also an OS (Operating System) or the like which is working on the computer and executes part or whole of the actual processing to realize the functions in accordance with instructions from the program codes.

Further, as a matter of course, the present invention involves such a case in which the program codes read out of the storage medium are written into a memory provided in a function add-on board mounted in the computer or a function add-on unit connected to the computer, and a CPU or the like incorporated in the function add-on board or unit executes part or whole of the actual processing in accordance with instructions from the program codes, thereby realizing the function of the above-described embodiment.

As fully described above, according to the embodiment, multi-viewpoint images can be automatically generated from a photographed image, and a high-quality three-dimensional image can be easily obtained.

Also, since the photographed image can be once recorded as digital image data and then supplied via a network, convenience in use is improved.

Further, it is possible to easily take a photograph of an object, to automatically generate multi-viewpoint images from a photographed image, and to easily print a high-quality stereoscopic image so that a user can observe a three-dimensional image of the object.

Additionally, by placing an optical member, such as a lenticular sheet, on the generated multi-viewpoint image, a stereophotographic printing system capable of allowing the user to observe a high-quality three-dimensional image of the object is realized.

While the present invention has been described with reference to what are presently considered to be the preferred embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. An image processing apparatus comprising:
depth map extracting means for extracting a depth map, which represents a depthwise distribution of an object, from a stereo image containing object images looking from multiple viewpoints and formed in the same image plane;
multi-viewpoint image sequence generating means for generating a multi-viewpoint image sequence of said object looking from the multiple viewpoints based on said stereo image and said depth map; and
three-dimensional image synthesizing means for synthesizing a three-dimensional image based on said multi-viewpoint image sequence.

2. An image processing apparatus according to claim 1, wherein said three-dimensional image synthesizing means synthesizes the three-dimensional image such that pixels of respective images of said multi-viewpoint image sequence, which have the same coordinates, are arranged as adjacent pixels in accordance with a viewpoint array of the images.

3. An image processing apparatus according to claim 2, wherein the respective images of said multi-viewpoint image sequence are generated by a process of modifying one viewpoint image among the object images, which constitute said stereo image, using said depth map.

4. An image processing apparatus according to claim 3, wherein said multi-viewpoint image sequence of said object is generated using viewpoints which are arranged spatially at equal intervals and in symmetrical relation about a viewpoint of the image subjected to the modifying process.

5. An image processing apparatus according to claim 4, wherein said stereo image is supplied as digital image data via a network from image recording means for recording said stereo image as the digital image data.

6. A stereophotographic printing system comprising:
a camera for photographing an object image;
a stereophotographic adapter mounted to said camera for photographing object images looking from multiple viewpoints, as a stereo image, in the same photographed image plane of said camera;
an image processing apparatus for extracting a depth map, which represents a depthwise distribution of an object, from said stereo image, generating a multi-viewpoint image sequence of said object looking from the multiple viewpoints based on said stereo image and said depth map, and synthesizing a three-dimensional image based on said multi-viewpoint image sequence; and
a printer for printing the three-dimensional image for enabling a stereoscopic image of said object to be observed with an optical member.

7. A stereophotographic printing system according to claim 6, wherein said image processing apparatus synthesizes the three-dimensional image such that pixels of respective images of said multi-viewpoint image sequence, which have the same coordinates, are arranged as adjacent pixels in accordance with a viewpoint array of the images.

8. A stereophotographic printing system according to claim 7, wherein the respective images of said multi-viewpoint image sequence are generated by a process of modifying one viewpoint image among the object images, which constitute said stereo image, using said depth map.

9. A stereophotographic printing system according to claim 8, wherein said multi-viewpoint image sequence of said object is generated using viewpoints which are arranged spatially at equal intervals and in symmetrical relation about a viewpoint of the image subjected to the modifying process.

10. A stereophotographic printing system according to claim 6, further comprising an image recording device for recording said stereo image as digital image data, wherein said image recording device outputs said digital image data to said image processing apparatus via a network.

11. A stereophotographic printing system according to claim 10, wherein said optical member is constituted by a lenticular sheet having a cyclic structure, and enables a stereoscopic image of said object to be observed when said optical member is laid on a print surface of the three-dimensional image printed by said printer.

12. An image processing method comprising the steps of:
a depth map extracting step of extracting a depth map, which represents a depthwise distribution of an object, from a stereo image containing object images looking from multiple viewpoints and formed in the same image plane;
a multi-viewpoint image sequence generating step of generating a multi-viewpoint image sequence of said object looking from the multiple viewpoints based on said stereo image and said depth map; and
a three-dimensional image synthesizing step of synthesizing a three-dimensional image based on said multi-viewpoint image sequence.

13. An image processing method according to claim 12, wherein said three-dimensional image synthesizing step synthesizes the three-dimensional image such that pixels of respective images of said multi-viewpoint image sequence, which have the same coordinates, are arranged as adjacent pixels in accordance with a viewpoint array of the images.

14. An image processing method according to claim 13, wherein the respective images of said multi-viewpoint image sequence are generated by a process of modifying one viewpoint image among the object images, which constitute said stereo image, using said depth map.

15. An image processing method according to claim 14, wherein said multi-viewpoint image sequence of said object is generated using viewpoints which are arranged spatially at equal intervals and in symmetrical relation about a viewpoint of the image subjected to the modifying process.

16. An image processing method according to claim 12, wherein said stereo image is supplied as digital image data via a network from a image recording device for recording said stereo image as the digital image data.

17. A stereophotographic printing method comprising the steps of:
a depth map extracting step of extracting a depth map, which represents a depthwise distribution of an object, from a stereo image generated by using a camera for photographing an object image and a stereophotographic adapter mounted to said camera for photographing object images looking from multiple viewpoints, as said stereo image, in the same photographed image plane of said camera;
a multi-viewpoint image sequence generating step of generating a multi-viewpoint image sequence of said object looking from the multiple viewpoints based on said stereo image and said depth map;
a three-dimensional image synthesizing step of synthesizing a three-dimensional image based on said multi-viewpoint image sequence; and
a printing step of printing the three-dimensional image for enabling a stereoscopic image of said object to be observed with an optical member.

18. A stereophotographic printing method according to claim 17, wherein said three-dimensional image synthesizing step synthesizes the three-dimensional image such that pixels of respective images of said multi-viewpoint image sequence, which have the same coordinates, are arranged as adjacent pixels in accordance with a viewpoint array of the images.

19. A stereophotographic printing method according to claim 18, wherein the respective images of said multi-viewpoint image sequence are generated by a process of modifying one viewpoint image among the object images, which constitute said stereo image, using said depth map.

20. A stereophotographic printing method according to claim 19, wherein said multi-viewpoint image sequence of said object is generated using viewpoints which are arranged spatially at equal intervals and in symmetrical relation about a viewpoint of the image subjected to the modifying process.

21. A stereophotographic printing method according to claim 20, wherein said stereo image is supplied as digital image data via a network from a image recording device for recording said stereo image as the digital image data.

22. A stereophotographic printing method according to claim 17, wherein a stereoscopic image of said object can be observed by placing said optical member on a print surface of the three-dimensional image printed by said printing step.

23. A storage medium product storing a processing program comprising the steps of:
a depth map extracting step of extracting a depth map, which represents a depthwise distribution of an object, from a stereo image containing object images looking from multiple viewpoints and formed in the same image plane;
a multi-viewpoint image sequence generating step of generating a multi-viewpoint image sequence of said object looking from the multiple viewpoints based on said stereo image and said depth map; and
a three-dimensional image synthesizing step of synthesizing a three-dimensional image based on said multi-viewpoint image sequence.

24. A storage medium product according to claim 23, wherein said three-dimensional image synthesizing step synthesizes the three-dimensional image such that pixels of respective images of said multi-viewpoint image sequence, which have the same coordinates, are arranged as adjacent pixels in accordance with a viewpoint array of the images.

25. A storage medium product according to claim 24, wherein the respective images of said multi-viewpoint image sequence are generated by a process of modifying one viewpoint image among the object images, which constitute said stereo image, using said depth map.

26. An image processing method according to claim 25, wherein said multi-viewpoint image sequence of said object is generated using viewpoints which are arranged spatially at equal intervals and in symmetrical relation about a viewpoint of the image subjected to the modifying process.
